(19) United States
(12) Patent Application Publication
(10) Pub. No.: US 2019/0077928 A1
(43) Pub. Date: Mar. 14, 2019

(54) CROSS-LINKED FLUOROPOLYMER, TAPE, PIPE, RISER TUBE AND FLOWLINE

(71) Applicant: DAIKIN INDUSTRIES, LTD., Osaka (JP)

(72) Inventors: Yuuki KUWAJIMA, Osaka (JP); Keiko KOGA, Osaka (JP); Hayato TSUDA, Osaka (JP)

(73) Assignee: DAIKIN INDUSTRIES, LTD., Osaka (JP)

(21) Appl. No.: 15/704,610

(22) Filed: Sep. 14, 2017

(51) Int. Cl. C08J 3/28; C08F 214/26; C08J 5/18; F16L 11/24; F16L 11/12; F16L 11/04; E21B 17/01

(52) U.S. Cl. CPC C08J 3/28; C08F 214/26; C08J 5/18; F16L 11/24; E21B 17/20; F16L 11/045; E21B 17/01; C08J 2327/18; F16L 11/12

(57) ABSTRACT

The invention provides a cross-linked fluororesin having excellent abrasion resistance against metal. The cross-linked fluororesin is obtainable by cross-linking a fluororesin. The fluororesin contains a tetrafluoroethylene unit and a vinylidene fluoride unit, and the tetrafluoroethylene unit represents 50.0 mol % or more of all the monomer units constituting the fluororesin.

### TECHNICAL FIELD

The invention relates to cross-linked fluoropolymers, tapes, pipes, riser tubes, and flowlines.

### BACKGROUND ART

Pipes used for offshore oil fields include risers (pipes for pumping up crude oil), umbilicals (integration of pipes for supplying chemicals for crude oil viscosity reduction for the purpose of controlling the pumping, power cables, and others), flowlines (pipes for transporting pumped crude oil which extend on the sea floor), and the like. They have various structures, and known pipes include metallic pipes and metal/resin hybrid pipes. In order to achieve weight reduction of pipes, use of metallic pipes tends to be reduced and metal/resin hybrid pipes are becoming the mainstream.

Patent Literature 1 relates to tubes such as a riser tube having a structure of body (carcass)/pipe/metallic reinforcement layer/anti-friction layer/metallic reinforcement layer/outer resin layer, and proposes to form the pipe from a fluororesin that is a copolymer containing copolymerized units derived from tetrafluoroethylene, vinylidene fluoride, and an ethylenically unsaturated monomer, and has a storage elastic modulus (E′), as measured at 170° C. by a dynamic viscoelasticity analysis, in the range of 60 to 400 MPa.

### CITATION LIST

### Patent Literature

Patent Literature 1: WO 2010/110129

### SUMMARY OF INVENTION

### Technical Problem

Since the resin pipe in Patent Literature 1 is formed from the fluororesin, Patent Literature 1 can solve problems such as biting of the resin pipe into the metallic reinforcement layer, deformation of the resin pipe, and cracking in the resin pipe.

In contrast, a layer sandwiched between metal layers and used for preventing the friction between the metals, such as the anti-friction layer mentioned above, needs to be formed from a material having excellent abrasion resistance against metal.

The invention is made in view of the above state of the art, and aims to provide a cross-linked fluororesin having excellent abrasion resistance against metal.

### Solution to Problem

The invention relates to a cross-linked fluororesin obtainable by cross-linking a fluororesin,

the fluororesin containing a tetrafluoroethylene unit and a vinylidene fluoride unit,

the tetrafluoroethylene unit representing 50.0 mol % or more of all the monomer units constituting the fluororesin.

The fluororesin is preferably obtainable by radiation cross-linking.

The fluororesin preferably further contains at least one ethylenically unsaturated monomer unit selected from the group consisting of:

ethylenically unsaturated monomers represented by the following formula (1):

CX¹¹X¹²=CX¹³ (CX¹⁴X¹⁵)ₙ₁₁X¹⁶

wherein X¹¹ to X¹⁶ are the same as or different from each other, and are each H, F, or Cl; and n¹¹ is an integer of 0 to 8, excluding tetrafluoroethylene and vinylidene fluoride; and

ethylenically unsaturated monomers represented by the following formula (2):

CX²X²²=CX²³−O(CX²⁴X²⁵)ₙ₂₁X²⁶

wherein X²¹ to X²⁶ are the same as or different from each other, and are each H, F, or Cl; and n²¹ is an integer of 0 to 8.

The cross-linked fluororesin preferably has a melt flow rate of 0 to 1 g/10 min.

The invention also relates to a tape containing the cross-linked fluororesin.

The invention also relates to a pipe including a first layer; a second layer disposed on the first layer; and a third layer disposed on the second layer, the first layer, the second layer, and the third layer being stacked in the given order from the inside of the pipe, the second layer being formed from the tape wrapped around the outer surface of the first layer.

The invention also relates to a riser tube including the pipe.

The invention also relates to a flowline including the pipe.

### Advantageous Effects of Invention

The invention can provide a cross-linked fluororesin having excellent abrasion resistance against metal.

### BRIEF DESCRIPTION OF THE DRAWINGS

FIGS. 1(a) to 1(c) are schematic views of examples of the shape of a tape.

FIG. 2 is a schematic view of an example the structure of the pipe.

FIG. 3 is a schematic view of an example of a method for wrapping the tape.

FIGS. 4(a) to 4(e) are schematic views of examples of the tape in a wrapped state.

FIG. 5 is a schematic view of another example of the structure of the pipe.

FIG. 6 is a schematic view of an example of the structure of a riser tube (or a flowline).

### DESCRIPTION OF EMBODIMENTS

The invention will be specifically described hereinbelow.

The fluororesin used in the cross-linked fluororesin of the invention contains a tetrafluoroethylene unit and a vinylidene fluoride unit, and the tetrafluoroethylene unit represents 50.0 mol % or more of all the monomer unit constituting the fluororesin. Use of this fluororesin enables production of a cross-linked fluororesin having excellent abrasion resistance against metal. This cross-linked fluororesin also has excellent rapid gas decompression resistance (RDG resistance) and chemical resistance.

The fluororesin preferably satisfies that the tetrafluoroethylene unit represents 50.0 to 95.0 mol % of all the monomer units constituting the fluororesin and the vinylidene fluoride unit represents 50.0 to 5.0 mol % of all the monomer units constituting the fluororesin.

The fluororesin more preferably satisfies that the tetrafluoroethylene unit represents 55.0 to 95.0 mol % of all the monomer units constituting the fluororesin and the vinylidene fluoride unit represents 45.0 to 5.0 mol % of all the monomer units constituting the fluororesin.

The fluororesin still more preferably satisfies that the tetrafluoroethylene unit represents 55.0 to 90.0 mol % of all the monomer units constituting the fluororesin and the vinylidene fluoride unit represents 45.0 to 10.0 mol % of all the monomer units constituting the fluororesin.

The fluororesin further more preferably satisfies that the tetrafluoroethylene unit represents 55.0 to 85.0 mol % of all the monomer units constituting the fluororesin and the vinylidene fluoride unit represents 45.0 to 15.0 mol % of all the monomer units constituting the fluororesin.

The fluororesin particularly preferably satisfies that the tetrafluoroethylene unit represents 55.0 to 80.0 mol % of all the monomer units constituting the fluororesin and the vinylidene fluoride unit represents 45.0 to 20.0 mol % of all the monomer units constituting the fluororesin.

The fluororesin most preferably satisfies that the tetrafluoroethylene unit represents 55.0 to 70.0 mol % of all the monomer units constituting the fluororesin and the vinylidene fluoride unit represents 45.0 to 30.0 mol % of all the monomer units constituting the fluororesin.

The fluororesin preferably further contains at least one ethylenically unsaturated monomer unit selected from the group consisting of ethylenically unsaturated monomers represented by the following formula (1), excluding tetrafluoroethylene and vinylidene fluoride, and ethylenically unsaturated monomers represented by the following formula (2).

CX¹¹X¹²=CX¹³(CX¹⁴X¹⁵)ₙ₁₁X¹⁶ Formula (1)

in the formula, X¹¹ to X¹⁶ are the same as or different from each other, and are each H, F, or Cl; and n¹¹ is an integer of 0 to 8.

CX²¹X²²=CX²³−O(CX²⁴x⁾ₙ₂₁X²⁶ Formula (2)

In the formula, X²¹ to X²⁶ are the same as or different from each other, and are each H, F, or Cl; and n²¹ is an integer of 0 to 8.

Preferred among the ethylenically unsaturated monomers represented by the formula (1) is at least one selected from the group consisting of CF₂═CFCl, CF₂═CFCF₃, those represented by the following formula (3):

CH₂=CF−(CF₂)ₙ₁₁X¹⁶ (3)

(wherein X¹⁶ and n¹¹ are defined as mentioned above), and those represented by the following formula (4):

CH₂=CH−(CF₂)ₙ₁₁X¹⁶ (4)

(wherein X¹⁶ and n⁰¹¹ are defined as mentioned above) ; more preferred is at least one selected from the group consisting of CF₂═CFCl , CH₂═CFCF₃, CH₂═CH—C₄F₉, CH₂═CH—C₆F₁₃, CH₂═CF—C₃F₆H, and CF₂═CFCF₃; and still more preferred is at least one selected from the group consisting of CF₂═CFCl₃, CH₂═CH—C₆F₁₃, and CH₂═CFCF₃.

Preferred among the ethylenically unsaturated monomers represented by the formula (2) is at least one selected from the group consisting of CF₂═CF—OCF₃, CF₂═CF—OCF₂CF₃, and CF₂═CF—OCF₂CF₂CF₃.

In the fluororesin further containing the ethylenically unsaturated monomer, preferably, the tetrafluoroethylene unit represents 50.0 to 94.9 mol % of all the monomer units constituting the fluororesin, the vinylidene fluoride unit represents 5.0 to 49.9 mol % of all the monomer units constituting the fluororesin, and the ethylenically unsaturated monomer unit represents 0.1 to 5.0 mol % of all the monomer units constituting the fluororesin.

More preferably, the tetrafluoroethylene unit represents 55.0 to 94.9 mol % of all the monomer units constituting the fluororesin, the vinylidene fluoride unit represents 5.0 to 44.9 mol % of all the monomer units constituting the fluororesin, and the ethylenically unsaturated monomer unit represents 0.1 to 5.0 mol % of all the monomer units constituting the fluororesin.

Still more preferably, the tetrafluoroethylene unit represents 55.0 to 90.0 mol % of all the monomer units constituting the fluororesin, the vinylidene fluoride unit represents 5.0 to 44.9 mol % of all the monomer units constituting the fluororesin, and the ethylenically unsaturated monomer unit represents 0.1 to 5.0 mol % of all the monomer units constituting the fluororesin.

Further more preferably, the tetrafluoroethylene unit represents 55.0 to 85.0 mol % of all the monomer units constituting the fluororesin, the vinylidene fluoride unit represents 10.0 to 44.9 mol % of all the monomer units constituting the fluororesin, and the ethylenically unsaturated monomer unit represents 0.1 to 5.0 mol % of all the monomer units constituting the fluororesin.

Particularly preferably, the tetrafluoroethylene unit represents 55.0 to 80.0 mol % of all the monomer units constituting the fluororesin, the vinylidene fluoride unit represents 15.0 to 44.9 mol % of all the monomer units constituting the fluororesin, and the ethylenically unsaturated monomer unit represents 0.1 to 5.0 mol % of all the monomer units constituting the fluororesin.

Most preferably, the tetrafluoroethylene unit represents 55.0 to 70.0 mol % of all the monomer units constituting the fluororesin, the vinylidene fluoride unit represents 25.0 to 44.9 mol % of all the monomer units constituting the fluororesin, and the ethylenically unsaturated monomer unit represents 0.1 to 5.0 mol % of all the monomer units constituting the fluororesin.

The fluororesin is preferably a copolymer containing:

50.0 to 90.0 mol % of a copolymerized unit of tetrafluoroethylene;

5.0 to 49.9 mol % of a copolymerized unit of vinylidene fluoride; and 0.1 to 10.0 mol % of a copolymerized unit of an ethylenically unsaturated monomer represented by the formula (1).

The fluororesin is more preferably a copolymer

containing: 55.0 to 90.0 mol % of a copolymerized unit of tetrafluoroethylene;

5.0 to 44.9 mol % of a copolymerized unit of vinylidene fluoride; and

0.1 to 10.0 mol % of a copolymerized unit of an ethylenically unsaturated monomer represented by the formula (1).

The fluororesin is still more preferably a copolymer containing:

55.0 to 85.0 mol % of a copolymerized. unit of tetrafluoroethylene;

10.0 to 44.9 mol % of a copolymerized unit of vinylidene fluoride; and

0.1 to 5.0 mol % of a copolymerized unit of an ethylenically unsaturated monomer represented by the formula (1).

The fluororesin is further more preferably a copolymer containing:

55.0 to 85.0 mol % of a copolymerized unit of tetrafluoroethylene;

13.0 to 44.9 mol % of a copolymerized unit of vinylidene fluoride; and

0.1 to 2.0 mol % of a copolymerized unit of an ethylenically unsaturated monomer represented by the formula (1).

In order not only to improve the mechanical strength of the fluororesin at high temperatures but also to enjoy particularly excellent low permeability of the fluororesin, the ethylenically unsaturated monomer represented by the formula (1) is preferably at least one monomer selected from the group consisting of CH₂═CH—C₄F₉, CH₂═CH—C₆F₁₃, and CH₂═CF—C₃F₆H. More preferably, the ethylenically unsaturated monomer represented by the formula (1) is at least one monomer selected from the group consisting of CH₂═CH—C₄F₉, CH₂═CH—C₆F₁₃, and CH₂═CF—C₃F₆H, and the fluororesin is a copolymer containing:

50.0 to 80.0 mol % of a copolymerized unit of tetrafluoroethylene;

19.5 to 49.9 mol % of a copolymerized unit of vinylidene fluoride; and

0.1 to 0.6 mol % of a copolymerized unit of the ethylenically unsaturated monomer represented by the formula (1). Still more preferably, the ethylenically unsaturated monomer represented by the formula (1) at least one monomer selected from the group consisting of CH₂═CH—C₄F₉, CH₂═CH—C₆F₁₃, and CH₂═CF—C₃F₆H, and the fluororesin is a copolymer containing:

55.0 to 80.0 mol % of a copolymerized unit of tetrafluoroethylene;

19.5 to 44.9 mol % of a copolymerized unit of vinylidene fluoride; and

0.1 to 0.6 mol % of a copolymerized unit of an ethylenically unsaturated monomer represented by the formula (1).

The fluororesin may also be a copolymer containing:

58.0 to 85.0 mol % of a copolymerized unit of tetrafluoroethylene;

10.0 to 41.9 mol % of a copolymerized unit of vinylidene fluoride; and

0.1 to 5.0 mol % of a copolymerized unit of an ethylenically unsaturated monomer represented by the formula (1).

The fluororesin is also preferably a copolymer containing:

50.0 to 90.0 mol % of a copolymerized unit of tetrafluoroethylene;

9.2 to 49.2 mol % of a copolymerized unit vinylidene fluoride; and

0.1 to 0.8 mol % of a copolymerized unit of an ethylenically unsaturated monomer represented by the formula (2).

The fluororesin is more preferably a copolymer containing:

55.0 to 90.0 mol % of a copolymerized unit of tetrafluoroethylene;

9.2 to 44.2 mol % of a copolymerized unit of vinylidene fluoride; and

0.1 to 0.8 mol % of a copolymerized unit of an ethylenically unsaturated monomer represented by the formula (2).

The fluororesin is still more preferably a copolymer containing:

58.0 to 85.0 mol % of a copolymerized unit of tetrafluoroethylene;

14.5 to 39.9 mol % of a copolymerized unit of vinylidene fluoride; and

0.1 to 0.5 mol % of a copolymerized unit of an ethylenically unsaturated monomer represented by the formula (2).

The fluororesin is also preferably a copolymer containing:

50.0 to 90.0 mol % of a copolymerized unit of tetrafluoroethylene;

5.0 to 49.8 mol % of a copolymerized unit of vinylidene fluoride;

0.1 to 10.0 mol % of a copolymerized unit of an ethylenically unsaturated monomer represented by the formula (1); and

0.1 to 0.8 mol % of a copolymerized unit of an ethylenically unsaturated monomer represented by the formula (2).

The fluororesin is more preferably a copolymer containing:

55.0 to 90.0 mol % of a copolymerized unit of tetrafluoroethylene;

5.0 to 44.8 mol % of a copolymerized unit of vinylidene fluoride;

0.1 to 10.0 mol % of a copolymerized unit of an ethylenically unsaturated monomer represented by the formula (1); and

0.1 to 0.8 mol % of a copolymerized unit of an ethylenically unsaturated monomer represented by the formula (2).

The fluororesin is still more preferably a copolymer containing:

55.0 to 85.0 mol % of a copolymerized unit of tetrafluoroethylene;

9.5 to 44.8 mol % of a copolymerized unit of vinylidene fluoride;

0.1 to 5.0 mol % of a copolymerized unit of an ethylenically unsaturated monomer represented by the formula (1); and

0.1 to 0.5 mol % of a copolymerized unit of an ethylenically unsaturated monomer represented by the formula (2).

The fluororesin is further more preferably a copolymer containing:

55.0 to 80.0 mol % of a copolymerized unit, of tetrafluoroethylene;

19.8 to 44.8 mol % of a copolymerized unit of vinylidene fluoride;

0.1 to 2.0 mol % of a copolymerized unit of an ethylenically unsaturated monomer represented by the formula (1); and

0.1 to 0.3 mol % of a copolymerized unit of an ethylenically unsaturated monomer represented by the formula (2). The fluororesin having this composition exhibits particularly excellent low permeability.

The fluororesin may also be a copolymer containing:

58.0 to 85.0 mol % of a copolymerized unit of tetrafluoroethylene;

9.5 to 39.8 mol % of a copolymerized unit of vinylidene fluoride;

0.1 to 5.0 mol % of a copolymerized unit of an ethylenically unsaturated monomer represented by the formula (1); and

0.1 to 0.5 mol % of a copolymerized unit of an ethylenically unsaturated monomer represented by the formula (2).

The fluororesin in which the amounts of the monomers fall within the above respective ranges has higher crystallinity and a higher storage elastic modulus at 170° C. than conventionally known copolymers containing tetrafluoroethylene, vinylidene fluoride, and a third component. Thus, this fluororesin has excellent mechanical strength, chemical resistance, and low permeability, at high temperatures. The low permeability at high temperatures herein means the low permeability against fluids such as methane, hydrogen sulfide, CO₂, methanol, and hydrochloric acid.

The amounts of the respective monomers of the copolymer can be calculated as the amounts of the monomer units by appropriate combination of NMR and elemental analysis in accordance with the types of the monomers.

The fluororesin preferably has a melt flow rate (MFR) of 0.1 to 500 g/10 min, more preferably 1 to 100 g/10 min.

The MFR refers to the mass (g/10 min) of a polymer flowing out of a nozzle (inner diameter: 2 mm, length: 8 mm) per 10 minutes at 297° C. and a 5-kg load using a melt indexer (Toyo Seiki Seisaku-sho, Ltd.) in conformity with ASTM D3307-G1.

The fluororesin preferably has a melting point of 180° C. or higher, and the upper limit thereof may be 290° C. The lower and upper limits thereof are more preferably 200° C. and 270° C., respectively.

The melting point refers to the temperature corresponding to the peak on an endothermic curve obtained by thermal analysis at a temperature-increasing rate of 10°/min using a differential scanning calorimeter RDC220 (Seiko Instruments Inc.) in conformity with ASTM D-4591.

The fluororesin preferably has a pyrolysis starting temperature (1% mass reduction temperature) of 360° C. or higher. The lower limit thereof is more preferably 370° C. The upper limit of the pyrolysis starting temperature may be 450° C., for example, as long as it falls within the above range.

The pyrolysis starting temperature refers to the temperature at which 1 mass % of a fluororesin subjected to a heating test is decomposed, and is a value obtainable by measuring the temperature at which the mass of the fluororesin subjected to the heating test is reduced by 1 mass % using a thermogravimetric/differential thermal analyzer (TG-DTA).

The fluororesin preferably has a storage elastic modulus (E′) of 60 to 400 MPa measured at 170° C. by dynamic viscoelasticity analysis.

The storage elastic modulus is a value determined at 170° C. by dynamic viscoelasticity analysis. Specifically, the storage elastic modulus is a value determined on a sample having a length of 30 mm, width of 5 mm, and thickness of 0.25 mm using a dynamic viscoelasticity analyzer DVA220 (IT Keisoku Seigyo Co., Ltd.) in a tensile mode at a clamp width of 20 mm, a measurement temperature of 25° C. to 250° C., a temperature-increasing rate of 2° C./min, and a frequency of 1 Hz. The storage elastic modulus (E′) at 170° C. is more preferably 80 to 350 MPa, still more preferably 100 to 350 MPa.

The measurement sample may be prepared by setting the molding temperature to a temperature higher than the melting point of the fluororesin by 50° C. to 100° C., molding the material into a film having a thickness of 0.25 mm under a pressure of 3 MPa, and cutting the film into a size of 30 mm in length and 5 mm in width, for example.

The fluororesin may also be produced by a polymerization technique such as solution polymerization, bulk polymerization, emulsion polymerization, or suspension polymerization. In order to industrially easily produce the fluororesin, emulsion polymerization or suspension polymerization is preferred.

In the above polymerization, a polymerization initiator, a surfactant, a chain-transfer agent, and a solvent may be used, and each of these components may be conventionally known one.

The polymerization initiator may be an oil-soluble radical polymerization initiator or a water-soluble radical polymerization initiator.

The oil-soluble radical polymerization initiator may be a known oil-soluble peroxide. Typical examples thereof include dialkyl peroxycarbonates such as diisopropyl peroxydicarbonate, di-n-propyl peroxydicarbonate, and di-sec-butyl peroxydicarbonate; peroxy esters such as t-butyl peroxyisobutyrate and t-butyl peroxypivalate; and dialkyl peroxides such as di-t-butyl peroxide, as well as di[perfluoro (or fluorochloro) acyl] peroxides such as di(ω-hydro-dodecafluoroheptanoyl)peroxide, di(ω-hydro-tetradecafluoroheptanoyl)peroxide, di(ω-hydro-hexadecafluorononanoyl)peroxide, di(perfluorobutyryl)peroxide, di(perfluorovaleryl)peroxide, di(perfluorohexanoyl)peroxide, di(perfluoroheptanoyl)peroxide, di(perfluorooctanoyl)peroxide, di(perfluorononanoyl)peroxide, di(ω-chloro-hexafluorobutyryl)peroxide, di(ω-chloro-decafluorohexanoyl)peroxide, di (ω-chloro-tetradecafluorooctanoyl)peroxide, ω-hydro-dodecafluoroheptanoyl-ω-hydro-hexadecafluorononanoyl-peroxide, ω-chloro-hexafluorobutyryl-ω-chloro-decafluorohexanoyl-peroxide, ω-hydro-dodecafluoroheptanoyl-perfluorobutyryl-peroxide, di(dichloropentafluorobutanoyl)peroxide, di(trichlorooctafluorohexanoyl)peroxide, di(tetrachloroundecafluorooctanoyl)peroxide, di(pentachlorotetradecafluorodecanoyl)peroxide, and di(undecachlorodotriacontafluorodocosanoyl)peroxide.

The water-soluble radical polymerization initiator may be a known water-soluble peroxide, and examples thereof include ammonium salts, potassium salts, and sodium salts of persulfuric acid, perborio acid, perchlorio acid, perphosphoric acid, and percarbonic acid, t-butyl permaleate, and t-butyl hydroperoxide. A reducing agent such as a sulfite or a sulfurous acid salt may be used in combination with a peroxide, and the amount thereof may be 0.1 to 20 times the amount of the peroxide.

The surfactant may be a known surfactant, and examples thereof include nonionic surfactants, anionic surfactants, and cationic surfactants. Preferred are fluorine-containing anionic fluorosurfactants, and more preferred are C4-C20 linear or branched fluorine-containing anionic fluorosurfactants optionally containing an ether-bond oxygen. (in other words, an oxygen atom may be present between carbon atoms). The amount thereof (relative to the water as a polymerization medium) is preferably 50 to 5000 ppm.

Examples of the chain-transfer agent, include hydrocarbons such as ethane, isopentane, n-hexane, and cyclohexane; aromatic substances such as toluene and xylene; ketones such as acetone; acetates such as ethyl acetate and butyl acetate; alcohols such as methanol and ethanol; mercaptans such as methyl mercaptan; and halogenated hydrocarbons such as carbon tetrachloride, chloroform, methylene chloride, and methyl chloride. The amount thereof may vary in accordance with the chain transfer constant of the compound used, and is usually 0.01 to 20 mass % relative to the polymerization solvent.

Examples of the solvent include water and solvent mixtures of water and an alcohol.

In the suspension polymerization, a fluorosolvent may be used in addition to water. Examples of the fluorosolvent include hydrochloro fluoroa 1 kanes such as CH₃CClF₂, CH₃CCl₂F, CF₃CF₂CCl₂H, and CF₂ClCF₂CFECl; chlorofluoroalkanes such as CF₂ClCFClCF₂CF₃ and CF₃CFClCFClCF₃; and perfluoroalkanes such as perfluorocyclobutane, CF₃CF₂CF₂CF₃, CF₃CF₂CF₂CF₂CF₃, and CF₃CF₂CF₂CF₂CF₂CF₃. Perfluoroalkanes are preferred. From the viewpoints of the suspension performance and economic efficiency, the amount of the flurosolvent is preferably 10 to 100 mass % relative to the aqueous medium.

The polymerization temperature may be any temperature, and may be 0° C. to 100° C. The polymerization pressure is appropriately determined in accordance with other polymerization conditions such as the type, amount, and vapor pressure of a solvent used, and the polymerization temperature. It may usually be 0, to 9.8 MPaG.

The cross-linked fluororesin of the invention is obtainable by cross-linking the fluororesin. This provides a cross-linked fluororesin having excellent abrasion resistance against metal. This cross-linked fluororesin also has excellent rapid gas decompression resistance and chemical resistance.

In order to provide a cross-linked fluororesin having even better abrasion resistance against metal, the cross-linking method is preferably radiation cross-linking.

In the radiation cross-linking, the fluororesin is irradiated with radiation so that it can be cross-linked. Examples of the radiation include electron beams, ultraviolet rays, gamma rays, X-rays, neutron beams, and high-energy ions. Preferred are electron beams because they have an excellent penetrating ability, a high dose rate, and are suitable for industrial production.

The irradiation may be performed by any method, such as a method with a conventionally known irradiation device.

The irradiation may be performed in any environment. The environment preferably has an oxygen concentration of 1000 ppm or less. It is more preferably in the absence of oxygen, still more preferably in vacuo or in an atmosphere of inert gas such as nitrogen, helium, or argon.

The irradiation temperature is preferably 0° C. to 300° C., more preferably 5° C. or higher, still more preferably 10° C. or higher, particularly preferably 20° C. or higher, while more preferably 100° C. or lower. The irradiation temperature is also preferably not higher than the glass transition temperature of the fluororesin, more preferably not higher than the melting point of the fluororesin. Too high an irradiation temperature may cause decomposition of the resin. Too low an irradiation temperature may cause insufficient cross-linking.

Preferably, the irradiation temperature falls within the above numerical range and is lower than the melting point of the fluororesin.

The irradiation temperature may be adjusted by any method, including known methods. Specific examples thereof include a method of holding the fluororesin in a heating furnace maintained at a predetermined temperature and a method of placing the fluororesin on an electric griddle and then heating the electric griddle by supplying an electric current to a built-in heater of the electric griddle or by means of an external heater.

The radiation exposure is preferably 10 to 500 kGy, more preferably 15 to 400 kGy, still more preferably 20 to 300 kGy, particularly preferably 30 to 250 kGy, most preferably 30 to 150 kGy. Too high or too low an exposure may cause insufficient cross-linking.

The cross-linked fluororesin preferably has a melt flow rate (MFR) of 0 to 1 g/10 min, more preferably 0 to 0.1 g/10 min.

The cross-linked fluororesin of the invention may also be obtainable by cross-linking a fluororesin composition containing the above fluororesin and any of different components other than the fluororesin. Examples of the different components include reinforcing fibers, fillers, plasticizers, processing aids, release agents, pigments, flame retardants, lubricants, photostabilizers, weather-resistance stabilizers, conductive agents, antistatics, ultraviolet absorbers, antioxidants, blowing agents, flavors, oils, softening agents, dehydrofluorinating agents, and nucleating agents.

Examples of the reinforcing fibers include carbon fiber, glass fiber, basalt fiber, metal fiber, aramid fiber, polyethylene fiber, polyamide fiber, silicon carbide fiber, polyester fiber, ceramic fiber, alumina fiber, boron fiber, mineral fiber, rock fiber, slag fiber, plant fiber, polyoxymethylene fiber, aromatic polyamide fiber, polyparaphenylene benzobisoxazole fiber, cellulose fiber, and lignin fiber. Examples of the fillers include polytetrafluoroet:hylene, mica, silica, talc, Celite, clay, titanium oxide, and barium sulfate. An example of the conductive agents is carbon black. Examples of the plasticizers include dioctyl phthalate and pentaerythritol. Examples of the processing aids include carnauba wax, sulfone compounds, low molecular weight polyethylene, and fluorine auxiliary agents. Examples of the dehydrofluorinating agents include organic onium compounds and amidines.

In order to provide a cross-linked fluororesin having even better abrasion resistance against metal, preferred among the above different components are reinforcing fibers.

A resin other than the above fluororesin or rubber may be blended as one of the different components. Preferred is a blend thereof with at least one selected from the group consisting of polyvinylidene fluoride (PVDF), polyether ether ketone (PEEK), and polytetrafluoroethylene (PTFE).

The invention also relates to a tape containing the aforementioned cross-linked fluororesin. The tape is preferably a band-like article having flexibility that allows the tape to be coiled (wrapped). The tape of the invention has excellent, abrasion resistance against metal. The tape of the invention also has excellent rapid gas decompression resistance and chemical resistance.

The tape of the invention may have any substantially band-like shape, and examples thereof are as follows.
(1) Those having a rectangular cross-section

The tape of Embodiment (1) has a simple shape and is easy to produce.

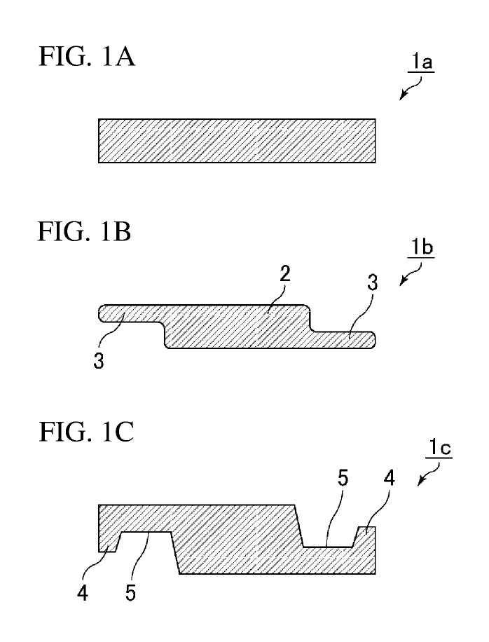

FIG. 1(a) shows an exemplary cross-section of the tape of Embodiment (1).
(2) Those having thin portions at the respective widthwise ends

The tape of Embodiment (2) can be wrapped around an object without a gap by wrapping the tape such that the corresponding thin portions of adjacent wraps of the tape overlap each other. Thus, even if applied to a tape layer constituting a flexible pipe for a high-temperature fluid stream, the tape can easily inhibit permeation of the high-temperature fluid to the outside. Further, overlapping of the thin portions can easily provide a tape layer having a uniform thickness.

The thin portions at the respective widthwise ends are preferably disposed on the opposite ends in the thickness direction. In other words, preferably, one thin portion is disposed on the upper end side while the other is disposed on the lower end side in the thickness direction.

FIG. 1(b) shows an exemplary cross-section of the tape of Embodiment (2).

A tape 1b has thin portions 3 that are thinner than a central portion 2 at the respective widthwise ends. One thin portion 3 is disposed on the upper end side while the ether thin portion 3 is disposed on the lower end side in the thickness direction of the tape 1b.

It should be noted that Embodiment (2) does not include Embodiment (3) described below.
(3) Those having a shape with a widthwise end being interlocked with the corresponding widthwise end of an adjacent wrap of the tape in a wrapped state

Examples of the tape of Embodiment (3) include those having a cross-section such as, but not limited to, a substantially Z-like shape, a substantially U-like shape, a substantially S-like shape, a substantially T-like shape, or a substantially I-like shape.

The tape of Embodiment (3) can provide a tape layer in which wraps of the tape are interlocked with each other by wrapping the tape such that a widthwise end of one wrap of the tape is engaged with the corresponding widthwise end of an adjacent wrap of the tape. Thus, when applied to a tape layer constituting a flexible pipe for a high-temperature fluid stream, the tape can be prevented from shifting during bending or twisting of the flexible pipe. This more securely enables prevention of outflow of the fluid passing through the flexible pipe.

The tape of Embodiment (3) particularly preferably has a substantially Z-like cross-section. Specifically, the tape preferably has thin portions at the respective widthwise ends and has protrusions extending from the respective thin portions at the widthwise ends in the opposite directions (counter directions) in the thickness direction.

Since this tape has key-like portions (key portions) at the respective widthwise ends, it can provide a tape layer in which the wraps of the tape are interlocked with each other by wrapping the tape such that key portions of adjacent wraps of the tape are engaged with each other, in other words, by wrapping the tape such that a recess defined by a protrusion and a thin portion of one wrap of the tape is fit into the corresponding protrusion of an adjacent wrap of the tape.

FIG. 1(c) shows an exemplary cross-section of the tape of Embodiment (3).

A tape 1c has a substantially Z-like cross-section. The tape 1c has thin portions 5 at the respective widthwise ends, and further has protrusions 4 extending from the two thin portions 5 in the opposite directions (counter directions) in the thickness direction.

The tape of the invention is particularly preferably the tape of Embodiment (3).

The tape of the invention can be produced by molding the fluororesin, if necessary together with any of the above different components, by a technique such as extrusion molding, pultrusion, press molding, melt infiltration, extrusion laminating, or dry powder coating, and then cross-linking the molded article. Any of these molding techniques may be combined. Alternatively, the fluororesin may be processed into filaments, if necessary together with any of the above different components, and then woven into a woven tape with a desired shape. In this case, the cross-linking may be performed either before or after weaving the fluororesin filaments.

The tape of the invention may have an appropriately adjusted width, thickness, and length in accordance with the use thereof. In the case of applying the tape of the invention to flexible pipes for high-temperature fluid streams such as riser tubes, the width may be 1 mm to 10 m and the thickness may be 10 μm to 5 cm, for example. The length may be determined in accordance with factors such as the amount of the tape to be used. In the case of applying the tape to flexible pipes for high-temperature fluid streams, the length may be about 1 m to 1000 km.

The cross-linked fluororesin of the invention can constitute a laminate. The laminate preferably includes a first layer, a second layer disposed on the first layer and formed from the aforementioned cross-linked fluororesin, and a third layer disposed on the second layer. Since the second layer is formed from the aforementioned cross-linked fluororesin, it can reduce the friction between the first layer and the third layer. In particular, even when the first layer and the third layer are metal layers, the second layer can be less likely to be abraded and can reduce the friction between the first layer and the third layer for a long period of time. The first layer and the second layer, and the third layer and the second layer may or may not be bonded to each other.

The laminate may further include a layer different from the first layer, the second layer, and the third layer. For example, in accordance with the use, an additional layer may be disposed on the surface of the first layer opposite to the second layer and/or on the surface of the third layer opposite to the second layer.

The first layer and the third layer may be layers formed from the same material, or may be layers formed from different materials. Examples of the materials to be used for the first layer and the third layer include metal, resin, and rubber. Preferred among these is metal. Reinforcing filaments may be disposed between the first layer and the third layer.

The first layer and the third layer are both particularly preferably formed from metal. In this embodiment, the friction between the first layer and the third layer increases. Thus, the effect of reducing the friction owing to the presence of the second layer may be significant. Further, metal is likely to be corroded due to contact with a high-temperature fluid. Thus, the effect of preventing corrosion of the third layer owing to the presence of the second layer may be significant.

The laminate is preferably a pipe. When the laminate is a pipe, the second layer is preferably formed from a tape containing the cross-linked fluororesin.

The invention also relates to a pipe including a first layer, a second layer disposed on the first layer, and a third layer disposed on the second layer, the first layer, the second layer, and the third layer being stacked in the given order from the inside of the pipe, the second layer being formed from the aforementioned tape wrapped around the outer surface of the first layer. The first layer and the second layer, and the third layer and the second layer may or may rot be bonded to each other.

In the second layer, the tape is preferably disposed such that the wraps of the tape is adjacent to each other in the width direction. Further, widthwise ends of adjacent wraps of the tape are preferably interlocked with each other. This embodiment can be achieved by the use of the tape of Embodiment (3), for example.

The second layer may include multiple layers of the tape.

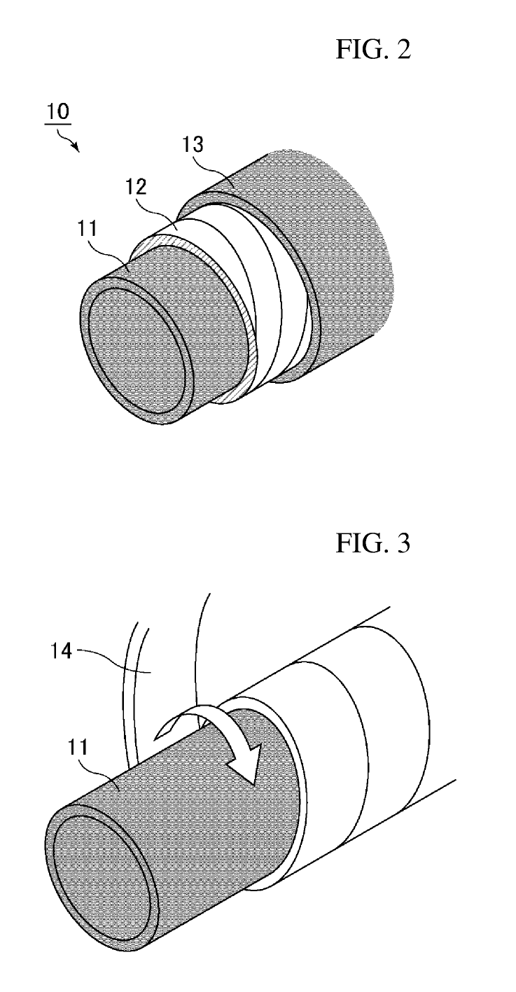

In the pipe of the invention, the first layer, the second layer, and the third layer each form a tube, the second layer is disposed on the first layer, and the third layer is disposed on the second layer. FIG. 2 schematically shows an exemplary structure of the pipe of the invention.

Since the second layer in the pipe of the invention is formed from the aforementioned tape, it can reduce the friction between the first layer and the third layer. In particular, even when the first layer and the third layer are metal layers, the second layer is less likely to be abraded and can reduce the friction between the first layer and the third layer for a long period of time. Further, the mechanical strength of the pipe is less likely to decrease even when used in a high-temperature environment. The pipe, when applied to a flexible pipe for a high-temperature fluid stream such as a riser tube, can inhibit permeation of the high-temperature fluid to the layer outside the second layer, and thus can prevent corrosion of the layer outside the second layer. This structure can also prevent a reduction in strength of the flexible pipe.

In the pipe of the invention, the tape layer (second layer) containing the resin has a better heat-insulating effect than the metal layers. Thus, the second layer can inhibit a temperature decrease inside the pipe (in a portion inside the second layer). This is especially effective in the case of transporting a material that suffers a rapid increase in viscosity and thereby becomes unable to flow inside the pipe when the temperature decreases. The heat-insulating effect can be further improved by foaming the tape to form cells therein, for example.

The second layer in the pipe of the invention is formed by wrapping the tape around the outer surface of the first layer. When the second layer is a tape-wrapping layer formed by wrapping the tape around the outer surface of the first layer, the wraps of the tape have play therebetween and the tape does not extend when the pipe is bent. Thus, this second layer can exert an effect of preventing reduction in physical properties or deformation of the tape layer after the pipe returns to the original state.

The tape may be wrapped in any way, and is preferably wrapped spirally around the outer surface of the first layer, for example. FIG. 3 schematically shows an exemplary method of wrapping the tape. A tape 14 (the tape of the invention) is spirally wrapped around the outer surface of a tubular first layer 11 in the direction indicated by the arrow in the figure.

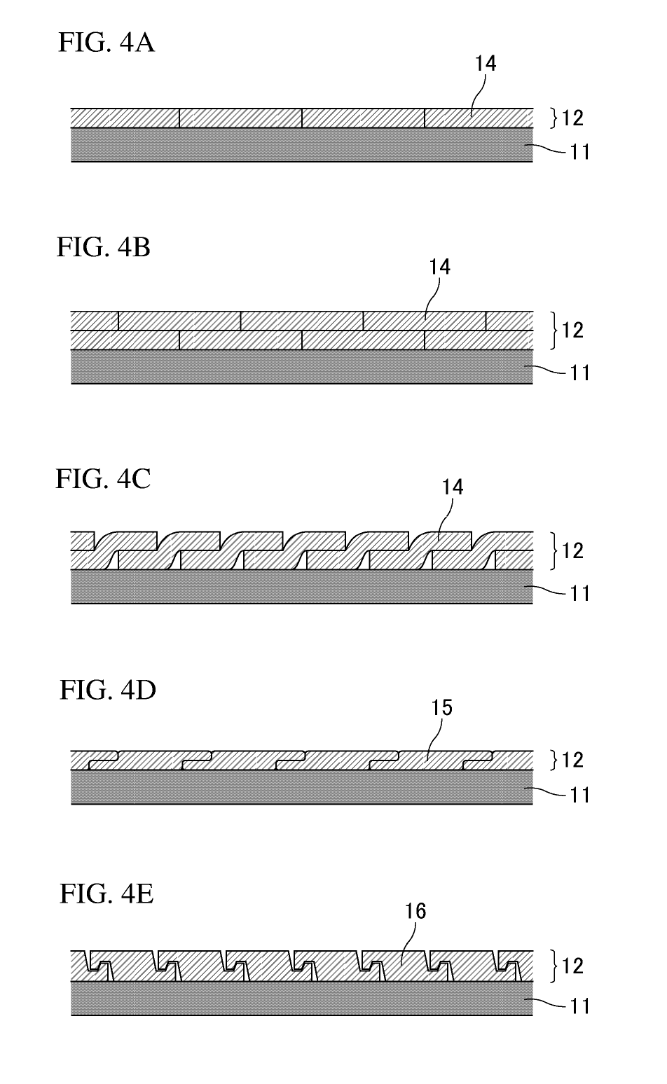

The tape may be wrapped around the outer surface of the first layer such that the corresponding widthwise ends of the adjacent wraps of the tape do not overlap each other (for example, see FIG. 4(a)). Another piece of the tape may be further wrapped in the same manner around the outer surface of the resulting tape-wrapping layer with the wrapping position being shifted so as to cover the boundaries of the previous wrapping of the tape (for example, see FIG. 4(b)). This more securely enables inhibition of permeation of a high-temperature fluid. In this case, the tape for the lower layer (inner layer) and the tape for the upper layer (outer layer) may be wrapped in the same direction. Still, the tapes are preferably wrapped in the opposite directions because the tensions applied to the pipe during wrapping are balanced and thus the tapes can be easily wrapped.

The tape may be wrapped such that the corresponding widthwise ends of the adjacent wraps of the tape overlap each other (for example, see FIG. 4(c)). This more securely enables inhibition of permeation of a high-temperature fluid. In this embodiment, the tapes may also be wrapped in multiple layers in either the same direction or the opposite directions.

In the case of the tape having thin portions at the respective widthwise ends, the tape is preferably wrapped such that the corresponding thin portions of the adjacent wraps of the tape overlap each other (for example, see FIG. 4(d)). This more securely enables inhibition of permeation of high-temperature fluid, and can also easily provide a tape-wrapping layer having a uniform thickness. In this embodiment, the tape may also be wrapped in multiple layers in either the same direction or the opposite directions.

In the case of the tape having shapes that can be interlocked with each other, the tape is preferably wrapped such that the corresponding widthwise ends of the adjacent wraps of the tape are engaged with each other (for example, see FIG. 4(e)). This can provide a tape-wrapping layer with the wraps of the tape interlocked with each other, and thus can prevent shifting of the tape when the pipe is bent or twisted. This consequently more securely enables inhibition of permeation of a high-temperature fluid, and can also easily provide a tape-wrapping layer having a uniform thickness. In this embodiment, the tape may also be wrapped in multiple layers in either the same direction or the opposite directions.

The tape may be wrapped using a known tape wrapper.

In the second layer, the corresponding widthwise ends of the adjacent wraps of the tape are preferably interlocked with each other. This embodiment may be achieved by wrapping the tape of Embodiment (3) around the outer surface of the first layer such that the corresponding widthwise ends of the adjacent wraps of the tape are engaged with each other, for example.

The third layer can be formed by covering the outer surface of the second layer with a required material by a known method, for example.

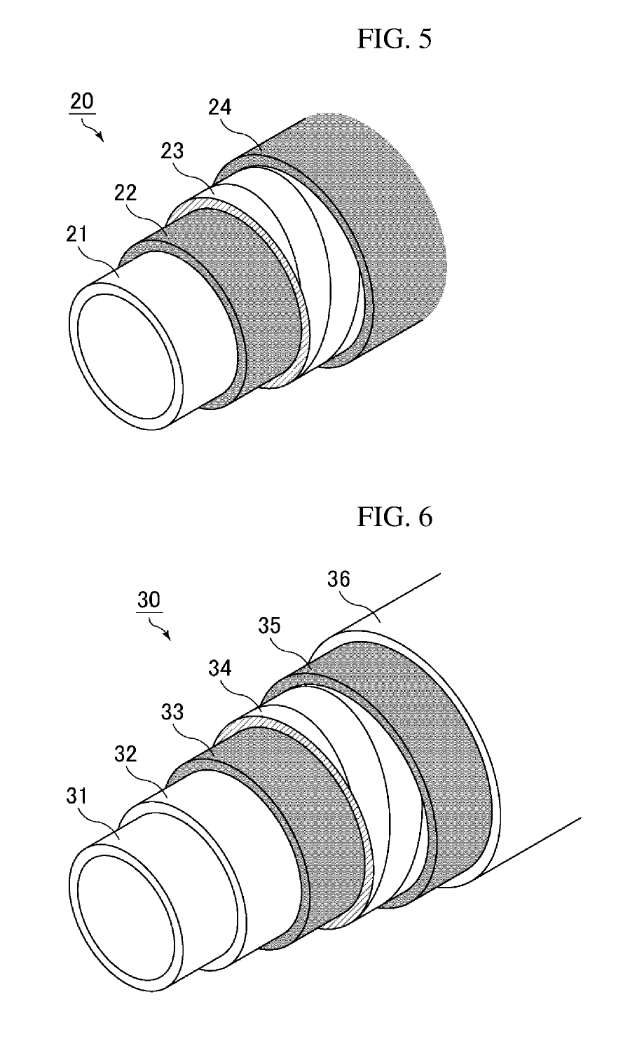

Preferably, the pipe of the invention further includes a flexible tube, the first layer is disposed on the outer surface of the tube, the second layer is formed by wrapping the tape around the outer surface of the first layer, and the third layer is disposed on the outer surface of the second layer. FIG. 5 schematically shows an exemplary structure of the pipe of this embodiment. A pipe 20 includes a flexible tube 21, a first layer 22, a second layer 23, and a third layer 24 stacked in the given order from the inside.

In this embodiment, a trilayer laminate of the first layer, the second layer, and the third layer is disposed on the outer layer of the flexible tube, and this laminate can reinforce the tube. In particular, when the first layer and the third layer are layers formed of metal, they can more sufficiently reinforce the tube. Since the second layer is formed from the aforementioned tape, it can reduce the friction between the first layer and the third layer. In particular, even when the first layer and the third layer are metal layers, the second layer is less likely to be abraded and can reduce the friction between the first layer and the third layer for a long period of time. Even when a high-temperature fluid is passed through the tube, the second layer can inhibit permeation of the high-temperature fluid from the second layer to the third layer, and thus can prevent corrosion of the third layer. Further, this can prevent a reduction in the effect of reinforcing the tube even under high-temperature conditions.

The flexible tube may have either a monolayer structure or a multilayer structure. The multilayer structure may be formed by any method, preferably known sequential extrusion molding or co-extrusion molding.

The tube may be constituted by any material capable of imparting flexibility to the tube, and any of known materials used for various flexible pipes may be selected in accordance with the use. An example of the material is a polymer, and specific examples thereof include fluoropolymers, polyether ether ketone (PEEK), polyimide, popolyether ketone, polyether ketone ketone, polyether ketone ether ketone ketone, polyamide, and mixtures thereof.

Examples of the fluoropolymers include the aforementioned fluororesin and polyvinylidene fluoride (PVDF).

The pipe of the invention may include an additional layer disposed on the outer surface of the third layer and/or an additional layer disposed on the inner surface of the tube.

Since the pipe of the invention has the aforementioned excellent characteristics, it can suitably be used as a flexible metal pipe disclosed in JP H07-276523 A, a high-temperature-fluid transport pipe disclosed in JP S61-6485 A, and a multilayer flexible pipe disclosed in US 2008/0314471 A, for example.

A riser tube and a flowline each including the aforementioned pipe of the invention are also encompassed by the invention. The riser tube and the flowline can suitably be used as a riser tube and a flowline for transporting a material from the sea floor to the surface of the sea in an offshore oil field or a gas field. Examples of the material include fluids such as crude oil, petroleum gas, and natural gas.

FIG. 6 shows an exemplary embodiment of the riser tube (or the flowline) of the invention. It should be noted that the riser tube and the flowline of the invention are not limited thereto.

A riser tube (or flowline) 30 includes a body (carcass) 31 serving as an innermost layer which can provide high-pressure resistance and maintain the pipe shape even when the riser tube (or flowline) 30 is used in the deep sea. The outer surface of the body 31 is covered with a flexible tube 32 serving as a fluid barrier layer. The tube 32 prevents a material passing through the riser tube (or flowline) from leaking to the outside.

The outer surface of the tube 32 is covered with a first layer 33 and a third layer 35 serving as reinforcing layers, and a second layer 34 serving as a friction-resistant layer is disposed between the first layer 33 and the third layer 35 so as to prevent the friction. The first layer 33 and the third layer 35 exhibit an effect of preventing burst of the riser tube (or flowline) due to the pressure of a material passing through the tube. The first layer 33 and the third layer 35 may be made of metal, and can be formed of metal strips wrapped in the opposite directions such that the riser tube can be resistant to stresses applied in different directions. The second layer is a layer formed by wrapping the tape of the invention around the outer surface of the first layer 33, and exhibits an effect of reducing the friction between the first layer 33 and the third layer 35. Since the second layer is formed from the tape of the invention, it has excellent abrasion resistance against the first layer 33 and the third layer 35, which are metal layers, and can reduce the friction between the first layer 33 and the third layer 35 for a long period of time. Further, since the tape of the invention has excellent low permeability even in a high-temperature environment, the presence of the second layer 34 can inhibit permeation of a high-temperature fluid (material passing through the riser tube (or flowline)) to the third layer 35. This consequently enables prevention of corrosion of the third layer 35. Since the tape of the invention has excellent mechanical strength even in a high-temperature environment, it can inhibit a reduction in strength of the second layer 34. This consequently enables prevention of a reduction in strength of the entire riser tube (or flowline).

In order to prevent damage to the tube 32 which may be caused by a contact with a metallic reinforcing layer, a thermoplastic resin layer may be disposed between the tube 32 and the body 31 or first layer 33. An outer layer resin 36 is disposed on the outer surface of the third layer 35, and plays a role of partitioning the inside and outside of the riser tube (or flowline). The outer layer resin 36 may be formed from polyethylene or polyamide.

In addition to the riser tube and the flowline, the cross-linked fluororesin or tape of the invention can be applied to other uses, and can suitably be used as a material for forming friction-resistant layers of metal pipe for transporting fluids such as crude oil and natural gas whether in the ground, on the ground, or on the sea floor, for example. Crude oil and natural gas contain carbon dioxide and hydrogen sulfide which cause corrosion of metal pipes. The cross-linked fluororesin or tape of the invention can block them to inhibit corrosion of metal pipes or to reduce the fluid friction due to highly viscous crude oil. In order to further improve the rigidity and strength of the friction-resistant layer when applied to the above uses, glass fiber, carbon fiber, aramid resin, mica, silica, talc, Celite, clay, titanium oxide, or the like may be added. In order to bond the fluororesin or tape to metal, adhesive may be used or the metal surface may be roughened. The cross-linked fluororesin or tape of the invention exhibits characteristics suitable as seals, bellows, diaphragms, hoses, tubes, and electric wires, such as gaskets and non-contact or contact packings (self-seal packings, piston rings, split ring packings, mechanical seals, and oil seals) requiring heat resistance, oil resistance, fuel oil resistance, LLC resistance, and steam resistance for high-temperature parts around automobile engines or portions requiring chemical resistance, such as engine bodies, main drive systems, valve train systems, lubrication and cooling systems, fuel systems, and intake and exhaust systems of automobile engines; transmission systems of driveline systems; steering systems of chassis; braking systems; and electrical parts (e.g., basic electrical parts, electrical parts of control systems, and electrical accessories). In addition to the automobile-related uses, the cross-linked fluororesin or tape of the invention are suitable for uses such as oil-, chemical-, heat-, steam-, or weather-resistant packings, O-rings, other sealants, diaphragms, and valves in transports such as shipping and aircraft; similar packings, O-rings, sealants, diaphragms, valves, hoses, rolls, tubes, chemical-resistant coatings, and linings used in chemical plants; similar packings, O-rings, hoses, sealants, belts, diaphragms, valves, rolls, and tubes used in food plant equipment and food machinery (including household items); similar packings, O-rings, hoses, sealants, diaphragms, valves, and tubes used in equipment for nuclear power plants; and similar packings, O-rings, hoses, sealants, diaphragms, valves, rolls, tubes, linings, mandrels, electric wires, expansion joints, belts, rubber plates, weather strips, and roll blades for plain paper copiers used in general industrial parts. Since the tape of the invention exhibits chemical resistance, low elution, and less flavor permeation, it can be applied to uses such as oil-, chemical-, heat-, steam-, or weather-resistant sealants, cap materials, belts, rolls, hoses, tubes, films, coatings, linings, joints, and containers in the medical and chemical fields.

The cross-linked fluororesin or tape of the invention can also be applied to the following uses:

articles for preventing adhesion of aquatic organisms used for preventing adhesion and breeding of underwater organisms on underwater structures (e.g., ships, buoys, port facilities, marine oil field facilities, waterways for cooling water for power plants, waterways for cooling water for plants, and floating passages);

various components of optical devices and products having a plate-like shape or a curved shape made of a film, resin, glass, metal, or the like;

tapes attached (and removed) so as to fix components such as wafers, to grind the backs of semiconductors, to dice semiconductors, to dice semiconductor packages, glass, and ceramics, and to protect the circuit surfaces during these processes in the semiconductor processes;

tapes for fixing electronic and optical components of mobile devices such as mobile phones and PDAs, digital cameras, and digital video cameras;

coating masking tapes;

electronic devices such as servers, computers for servers, desktop computers, word processors, keyboards, and video game consoles, and portable electronic devices such as laptops, electronic dictionaries, PDAs, mobile phones, handheld game consoles, and portable audio players;

optical display devices and components thereof such as liquid crystal displays, transmissive liquid crystal display devices, reflective LCD panels, plasma displays, SEDs, LEDs, organic ELs, inorganic ELs, liquid crystal projectors, rear projectors, liquid crystal panels, backlight devices (for preventing variations and inhibiting temperature unevenness), TFT substrates, electron emitters, electron source substrate/face plate (for weight reduction)/display panel frame composite products, light emitters, charge-injection-type light emitters, and clocks;

light-emitting and illuminating devices such as lasers, semiconductor lasers, light-emitting diodes, fluorescent lamps, incandescent lamps, luminous dots, light emitter arrays, illuminating units, surface light-emitting devices, and document -illuminating devices;

inkjet printing (ink head) devices and components thereof such as single or combined print heads (e.g., heaters, insulators, and thermal storage layers) for inkjet printing (where inks are ejected owing to heat energy), line heads, long inkjet print heads, solid ink jet devices, heat sinks for inkjet print heads, ink cartridges, silicon substrates for inkjet print heads, inkjet printer drivers, and heat sources (e.g., halogen lamp heaters) for heating inkjet recording paper;

electrophotographic devices, image-forming devices, and components thereof composed of, for example, toner cartridges, devices equipped with laser sources, scanning optical devices (e.g., light emitting units, deflection scanning polygon mirrors, polygon mirror rotation driving motors, optical components for sending the data to photoconductor drums), exposure devices, developers (e.g., photoconductor drums, light receivers, development rollers, development sleeves, cleaning devices), transfer devices (e.g., transfer rolls, transfer belts, intermediate transfer belts), fixing devices (e.g., fixing rolls (including cores, peripheral components, halogen heaters), surf heaters, electromagnetic induction heaters, ceramic heaters, fixing films, film-heating devices, heating rollers, pressure rollers, heating units, pressure components, belt nips), sheet-cooling devices, sheet.-mounting devices, sheet-discharge devices, and sheet-processing devices;

other recording devices such as thermal transfer recording devices (ribbons), dot printers, and dye-sublimation printers;

semiconductor-related components such as semiconductor devices, semiconductor packages, semiconductor-encapsulating cases, semiconductor die bonding materials, semiconductor chips for driving liquid crystal display elements, CPUs, MPUs, memories, power transistors, and power transistor packages;

circuit boards such as printed circuit boards, rigid circuit boards, flexible circuit boards, ceramic circuit boards, build-up circuit boards, mounted boards, high-density printed circuit boards, (tape carrier packages), TABs, hinge mechanisms, slide mechanisms, through holes, resin packaging, encapsulants, mutilayer resin molded articles, and multilayer substrates;

recording devices, recording and reproducing devices, and components thereof such as CDs, DVDs (e.g., optical pick-ups, laser generators, laser receivers), Blu-ray discs, DRAMs, flash memories, hard disk drives, optical recording and reproducing devices, magnetic recording and reproducing devices, magneto-optical recording and reproducing devices, information storage media, optical storage discs, magneto-optical storage media (e.g., light-transmitting substrates, optical interference layers, domain wall displacement layers, intermediate layers, recording layers, protective layers, radiation layers, information tracks), light receivers, photodetectors, optical pick-up devices, magnetic heads, magnetic heads for magneto-optical recording, semiconductor laser chips, laser diodes, and laser-driven ICs;

image recording devices and components thereof such as digital cameras, film cameras, digital single-lens reflex cameras, film single-lens reflex cameras, digital cameras, digital video cameras, camcorders, ICs for camcorders, lights for video cameras, electronic flashes, image sensing devices, video camera tube cooling devices, image sensing devices, image sensors, CCDs, lens barrels, image sensors and information processing devices including the same, X-ray absorption patterns, X-ray mask structures, radiography systems, X-ray lithographic devices, X-ray flat panel detectors, digital radiography systems, X-ray area sensor substrates, sample cooling holders for electron microscopes, electron beam lithography systems (e.g., electron guns, electron guns, electron beam lithography systems), radiation detectors and radiation image sensing devices, scanners, image scanners, image sensors for motion pictures and image sensors for still pictures, and microscopes;

tapes used in heat-radiation materials of battery devices such as primary batteries (e.g., alkaline batteries, manganese batteries), secondary batteries (e.g., lithium ion batteries, nickel-metal hydride batteries, lead-acid batteries), electric double-layer capacitors, electrolytic capacitors, assembled batteries, solar cells, solar cell module installation structures, photoelectric conversion substrates, photovoltaic device arrays, power generation devices, and fuel cells (e.g., power generation cells, housing exteriors, fuel tank interiors);

power sources and components thereof such as power sources (rectifier diodes, transformers), DC/DC converters, switched-mode power supplies (forward mode), current leads, superconducting systems;

motors and components thereof such as motors, linear motors, planar motors, oscillating wave motors, motor coils, circuit units for rotation control driving, motor drivers, inner rotor motors, and oscillating wave actuators;

deposited film producing devices (temperature constant, quality stabilized) and components thereof such as vacuum-processing devices, semiconductor manufacturing devices, vapor deposition devices, single crystal semiconductor thin layer manufacturing devices, plasma-enhanced CVD devices, microwave plasma-enhanced. CVD devices, sputtering devices, vacuum chambers, vacuum pumps, evacuation devices such as cryotraps and cryopumps, electrostatic chucks, vacuum chucks, wafer pin chucks, sputtering targets, semiconductor lithography systems, lens-holding devices and projection lithography systems, and photomasks;

various manufacturing devices and components thereof such as heat processing devices utilizing resistance heating, induction heating, or infrared heating, driers, annealers, laminators, reflow systems, heat-bonding (compression) devices, injection molding devices (e.g., nozzles, heating parts), dies and molds for resin, LIM systems, roll formers, reformed gas manufacturing (e.g., reforming parts, catalyst parts, heating parts), stampers (e.g., film-shaped, roller-shaped, for storage media), bonding tools, catalyst reactors, chillers, coloring devices for color filter substrates, resist heating and cooling devices, welding machines, films for magnetic induction heating, anti-condensation glass, residual liquid amount detectors, and heat exchangers;

heat-insulating devices such as thermal insulations, vacuum thermal insulations, and radiant thermal insulation;

chassis, housings, and exterior covers of various electronic and electric devices and manufacturing devices;

radiation parts such as radiators, openings, heat pipes, heat sinks, fins, fans, and radiating connectors;

cooling parts such as pettier devices, thermoelectric generators, and water cooling parts;

temperature adjusters, temperature controllers, temperature detectors, and components thereof;

components relating to heating elements such as thermistors, thermoswitches, thermostats, thermal fuses, over voltage protection devices, thermal protectors, ceramic heaters, flexible heaters, heater/thermal conductive plate/thermal insulation composites, heater connectors, and electrode terminal parts;

electromagnetic shielding parts such as radiation parts with high emissivity, electromagnetic shielding, and electromagnetic absorbent materials;

tapes used for manufacturing of portable electronic devices such as smartphones and tablet personal computers and for fixing of image display modules such as liquid crystal display modules and organic EL modules;

various articles used in manufacturing of portable electronic devices such as electronic notebooks, mobile phones, PHS, digital cameras, audio players, televisions, laptops, smartphones, tablet personal computers, and game consoles, and electronic devices such as wall-mounted televisions, monitors, and personal computers;

tapes for fixing of protective panels of image display regions of portable electronic devices such as smartphones and tablet personal computers, and image display modules such as liquid crystal display modules with the surface layer covered with glass and organic EL modules; and

tapes for bonding of protective panels and image display modules and for fixing of image display modules on housings or supports with flat attachment sites (because the tape of the invention can also give excellent adhesion between rigid parts).

The aforementioned laminate can also be applied to pipes. In this case, pipes formed from the laminate can be produced by a typical method without any limitation. The pipes include corrugated tubes.

Use of the tape, laminate, pipe, riser tube, or flowline in a high-temperature environment is also encompassed by the invention. The high temperature herein means 100° C. or higher, preferably 130° C. or higher, more preferably 150° C.; or higher. The upper limit thereof may be 200° C., for example.

### EXAMPLES

The invention will be described below referring to, but are not limited to, examples.

The parameters in the examples were determined by the following methods.

### Composition of Fluororesin

The composition of the fluororesin was determined by ¹⁹F-NMR at a measurement temperature of the melting point of the polymer +20° C. using a nuclear magnetic resonance device AC300 (Bruker-Biospin), appropriately in combination with elemental analysis in accordance with the integral value of the peaks and the types of the monomers.

### Melting Point (° C.) of Fluororesin

The melting point was determined from the peak on an endothermic curve obtained by thermal analysis at a temperature-increasing rate of 10° C./min using a differential scanning calorimeter RDC220 (Seiko Instruments Inc.) in conformity with ASTM D-4591.

### Melt Flow Rate (MFR) of Fluororesin

The MFR was defined as the mass (g/10 min) of a polymer flowing out of a nozzle (inner diameter: 2 mm, length: 8 mm) per 10 minutes at 297° C. and a 5-kg load using a melt indexer (Tcyo Seiki Seisaku-sho, Ltd.) in conformity with ASTM D3307-01.

In the examples and the comparative example, a film of the fluororesin shown in Table 1 was prepared.

TABLE 1

| | | Melting | |
|---|---|---|---|
| | | point | MFR (g/10 min) |
| | Composition | (° C.) | (preset temperature) |
| Fluororesin (1) | TFE/VDF/CH₂ = CHCF₂CF₂CF₂CF₂CF₂CF₃ | 215 | 2.1 |
| | copolymer | | (297° C.) |
| | 60.0/39.7/0.3 (mol %) | | |

### Example 1

A 2-mm-thick molded article of the fluororesin (1) was put into an electron beam processing container of an electron beam processing system (NHV Corp.), and then nitrogen gas was introduced thereinto so that the inside of the container was filled with nitrogen. The temperature inside the container was increased up to 120° C. and stabilized. Then, the 2-mm-thick molded article was irradiated with electron beams at 80 kGy with an electron beam accelerating voltage of 3000 kV and an exposure intensity of 20 kGy/5 min. Thereby, the polymer was cross-linked by the electron beams.

The resulting cross-linked molded article was subjected to an abrasion test under the conditions shown in Table 2 using a thrust tester, and the abrasion loss was determined. Table 3 shows the result.

### Comparative Example 1

The abrasion test was performed in the same mariner as in Example 1 except that the electron-beam cross-linking was not performed, and the abrasion loss was determined. Table 3 shows the result.

### Examples 2 to 5

Cross-linked molded articles were obtained and the abrasion test was performed in the same manner as in Example 1 except that the conditions of the electron-beam cross-linking were changed as shown in Table 3. Table 3 shows the results.

TABLE 2
Conditions for thrust tester

| | |
|---|---|
| Contact pressure | 4.5 kgf/cm² |
| Rotational speed | 1 m/s |
| Abrasion time | 2.5 min |

TABLE 3

| | | | Comparative | | | | |
|---|---|---|---|---|---|---|---|
| | | Example 1 | Example 1 | Example 2 | Example 3 | Example 4 | Example 5 |
| Fluororesin | | Fluororesin (1) | Fluororesin (1) | Fluororesin (1) | Fluororesin (1) | Fluororesin (1) | Fluororesin (1) |
| Electron-beam | Temperature inside | 120 | Not performed | 25 | 25 | 180 | 180 |
| cross-linking | container (° C.) | | | | | | |
| | Accelerating | 3000 | | 3000 | 3000 | 3000 | 3000 |
| | voltage (kV) | | | | | | |
| | Exposure (kGy) | 80 | | 40 | 120 | 40 | 120 |
| Abrasion loss | g | 0.0641 | 0.1642 | 0.0778 | 0.0612 | 0.0842 | 0.0637 |

| | | | | | | |
|---|---|---|---|---|---|---|
| MFR after electron-beam cross-linking | 0.01 | 2.1 | 0.01 | 0.01 | 0.01 | 0.01 |

### REFERENCE SIGNS LIST

1a, 1b, 1c: tape
2: central portion
3: thin portion
4: protrusion
5: thin portion
10: pipe
11: first layer
12: second layer
13: third layer
14, 15, 16: tape
20: pipe
21: flexible tube
22: first layer
23: second layer
24: third layer
30: riser tube or flowline
31: body (carcass)
32: flexible tube
33: first layer
34: second layer
35: third layer
36: outer layer resin

1. A cross-linked fluororesin obtainable by cross-linking a fluororesin,
the fluororesin containing a tetrafluoroethylene unit and a vinylidene fluoride unit,
the tetrafluoroethylene unit representing 50.0 mol % or more of all the monomer units constituting the fluororesin.

2. The cross-linked fluororesin according to claim 1, which is obtainable by radiation cross-linking the fluororesin.

3. The cross-linked fluororesin according to claim 1,
wherein the fluororesin further contains at least one ethylenically unsaturated monomer unit selected from the group consisting of:
ethylenically unsaturated monomers represented by the following formula (1):
CX¹¹X¹²=CX¹³(CX¹⁴X¹⁵)ₙ₁₁X¹⁶
wherein X¹¹ to X¹⁶ are the same as or different from each other, and are each H, F, or Cl; and n¹¹ is an integer of 0 to 8, excluding tetrafluoroethylene and vinylidene fluoride; and
ethylenically unsaturated monomers represented by the following formula (2):
CX²¹X²²=CX²³−O(CX²⁴X²⁵)ₙ₂₁X²⁶
wherein X²¹ to X²⁶ are the same as or different from each other, and are each H, F, or Cl; and n²¹ is an integer of 0 to 8.

4. The cross-linked fluororesin according to claim 1, which has a melt flow rate of 0 to 1 g/10 min.

5. A tape comprising the cross-linked fluororesin according to claim 1.

6. A pipe comprising:
a first layer;
a second layer disposed on the first layer; and
a third layer disposed on the second layer,
the first layer, the second layer, and the third layer being stacked in the given order from the inside of the pipe,
the second layer being formed from the tape according to claim 5 wrapped around the outer surface of the first layer.

7. A riser tube comprising the pipe according to claim 6.

8. A flowline comprising the pipe according to claim 6.
